(19) United States
(12) Patent Application Publication
(10) Pub. No.: US 2005/0174925 A1
(43) Pub. Date: Aug. 11, 2005

(54) Optical disc substrate fabrication method, mold and optical disc

(75) Inventor: Akira Mizuta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/048,933

(22) Filed: Feb. 3, 2005

(30) Foreign Application Priority Data
Feb. 9, 2004 (JP) 2004-31835

(51) Int. Cl. G11B 7/24

(52) U.S. Cl. 369/275.5; 369/275.3

(57) ABSTRACT

A disc substrate is injection-molded with a mold provided with a cavity and an angled surface portion. The cavity forms the disc substrate by an injected molten resin spreading to a circumference of and filling the cavity. The angled surface portion, which is formed at a predetermined region of an area of the cavity that molds an outer periphery portion of a recording surface of the disc substrate, gradually reduces a height dimension of the outer periphery portion from an inner side toward an outer side of the outer periphery portion. Of a disc substrate molded by this mold, an outer periphery portion has a smaller rate of contraction because molten resin charged into the cavity first solidifies quicker, and a center side has a larger rate of contraction because molten resin charged into the cavity later solidifies more slowly than at the outer periphery portion.

### CROSS-REFERENCE TO RELATED APPLICATION

This application claims priority under 35 USC 119 from Japanese Patent Application No. 2004-031835, the disclosure of which is incorporated by reference herein.

### BACKGROUND OF THE INVENTION

1. Field of the Invention

The present invention relates to an optical disc substrate fabrication method, which structures an optical disc by fabrication of an optical disc substrate by injection-molding and lamination of a cover sheet onto an information recording surface of the optical disc substrate, and relates to an optical disc which includes the optical disc substrate fabricated by this optical disc substrate fabrication method.

2. Description of the Related Art

As optical discs which are capable of replaying and recording information using laser light, for example, CD (compact disc), CD-R (compact disc-recordable), DVD (digital versatile disc), DVD-R (digital versatile disc-recordable) and the like are widely used. In recent years, in view of demands for storage of even greater amounts of information, such as video information and the like, on these optical discs, development of higher densities has been progressing.

These optical discs are fabricated by, for example, laminating a thin film-form cover sheet, which is a resin film serving as a backing material, onto a recording surface of a disc substrate made of resin, at which surface an information recording layer is formed, and forming a transparent cover layer on the disc substrate with this cover sheet. A disc substrate structuring an optical disc (an optical disc substrate) is fabricated by injection-molding using a mold 200 as shown in FIGS. 12A and 12B.

In this mold 200, a stamper 220, for forming grooves in the recording surface of the disc substrate, is disposed at a fixed mold 202 side of the mold 200. As shown in FIG. 12A, when a movable mold 204 is clamped to the fixed mold 202, the stamper 220 is pressed and fixed by a stamper holder 206, which is disposed at the movable mold 204 side of an outer periphery portion vicinity of the stamper 220.

Then, at a time of molding, a molten resin M, which is the raw material of the disc substrate, is injected through a direct gate 210 from a runner 212, which is provided at a center of the fixed mold 202, into a cavity 208. The molten resin M flows in a radiating manner from a center side to an outer side of the cavity 208 and fills in the cavity 208. By injection-molding using the mold 200 of this form, a circular plate-form disc substrate, in which the grooves of the stamper 220 have been transcribed to the recording surface, is fabricated.

However, when a disc substrate is fabricated by injection-molding as described above, of the molten resin M that is injected into the cavity 208 of the mold 200, a portion MA which initially fills an outer periphery portion vicinity of the cavity 208 (see FIG. 12B) has a faster cooling rate than a portion MB which subsequently fills regions other than the outer periphery portion of the cavity 208. A rate of contraction of the portion MA which solidifies quicker is smaller and a rate of contraction of the portion MB is larger. Consequently, as shown in FIG. 13, a disc substrate 222, which is formed by the molten resin M solidifying, is thinner at the MB portion than at the MA portion. Thus, an outer periphery portion 224A of a recording surface 224 side of the disc substrate 222 has a shape which rises in a protruding form.

Hence, in an optical disc 230 which is fabricated by laminating a thin film-form cover sheet 226 onto the recording surface 224 of this disc substrate 222, at an outer periphery portion vicinity of the cover sheet 226 which is laminated onto the outer periphery portion 224A vicinity of the recording surface 224 of the disc substrate 222, curvature is made large and it is difficult to closely adhere the cover sheet 226 to the recording surface 224. At an optical disc in which a height dimension of the outer periphery portion 224A (the rising portion) is large, bubbles will be left between the disc substrate 222 and the cover sheet 226 from a vicinity of a boundary between the outer periphery portion 224A and a flat face portion 224B to a distal end side of the outer periphery portion 224A. An optical disc 230 at which these residual bubbles AR are present will be found unsatisfactory in an inspection of product appearance. Consequently, a reduction in production yield of the optical discs 230 in which these residual bubbles AR are caused is problematic.

### SUMMARY OF THE INVENTION

In consideration of the circumstances described above, an object of the present invention is to provide an optical disc substrate fabrication method in which residual bubbles will not be formed between a cover sheet and an information recording surface of the optical disc substrate when the cover sheet is laminated to the information recording surface. A further object is to, by employing the optical disc substrate fabricated by this optical disc substrate fabrication method, provide an optical disc with which a problem of residual bubbles occurring when a cover sheet is laminated to an information recording surface of an optical disc substrate can be eliminated and product quality can be improved.

In order to achieve the objects described above, a first aspect of the present invention is a method for fabricating an optical disc substrate which is to be employed in an optical disc on which information can be at least one of replayed and recorded for replay with laser light, the optical disc substrate being fabricated by injection-molding and the optical disc substrate structuring the optical disc by lamination of a thin film-form cover sheet at an information recording surface of the optical disc substrate, the cover sheet protecting the information recording surface, the method including: forming an outer periphery portion of the information recording surface of the optical disc substrate, including forming a height of the outer periphery portion, in a region of up to 1 mm from an outer peripheral edge of the optical disc substrate to an inner side thereof along a surface direction of the information recording surface, to a relative height dimension within a range of 1 to 7 μm with respect to a region that is beyond said 1 mm.

In the first aspect of the present invention, the optical disc substrate that structures the optical disc is subjected to an outer periphery portion-forming step in a fabrication process thereof. Thus, the outer periphery portion of the information recording surface of the optical disc substrate is formed, within the region of up to 1 mm to the inner side along surface directions from the outer periphery of the information recording surface of the optical disc substrate, such that height dimensions thereof are within the 1 to 7 μm range relative to regions beyond the 1 mm range.

As a result, with the optical disc substrate at which a difference in height dimensions between this predetermined region of the outer periphery portion of the information recording surface and the region beyond this predetermined region is made small (i.e., within the 1 to 7 μm range), when the thin film-form cover sheet is laminated onto the information recording surface of the optical disc substrate, curvature of an outer periphery portion vicinity of the cover sheet, which is laminated at the outer periphery portion vicinity of the information recording surface, is made smaller. Thus, close adherence of the cover sheet to the information recording surface (i.e., the outer periphery portion) in the outer periphery portion vicinity is excellent. Consequently, residual bubbles between the optical disc substrate and the cover sheet will not occur.

A second aspect of the present invention is the optical disc substrate fabrication method of the first aspect, in which forming the outer periphery portion includes carrying out injection-molding with a mold which includes: a cavity which molds the optical disc substrate by molten resin, which is injected into the cavity from a center thereof, spreading and filling to a circumference of the cavity; and an angled surface portion which is provided at a predetermined range of an area of the cavity that is for molding the outer periphery portion, and which makes a height dimension of the outer periphery portion gradually smaller from the inner side toward the outer side of the outer periphery portion.

In the second aspect of the present invention, in the injection-molding step which is included in the outer periphery portion-forming step described above, when the molten resin is injected into the cavity of the mold from the center thereof, the molten resin fills in the cavity while spreading toward the circumference. Because of the angled surface portion, at a predetermined range of an area of the cavity that will mold the outer periphery portion of the information recording surface of the optical disc substrate, the outer periphery portion is filled such that height dimensions of the outer periphery portion gradually decrease from the inner side toward the outer side.

As a result, at the optical disc substrate formed using this mold, because a rate of contraction of the outer periphery portion is smaller due to the molten resin that was charged into the cavity of the mold first solidifying quicker and a rate of contraction at a center side is larger due to the molten resin that was subsequently charged into the cavity solidifying later than the outer periphery portion, a relative difference between height dimensions thereof is made smaller and it is possible to form the predetermined region at the outer periphery portion of the information recording surface with relative height dimensions within the range of 1 to 7 μm relative to regions beyond the predetermined region, as described above.

Thus, with this injection-molding step, because it is possible to form the outer periphery portion of the information recording surface of the optical disc substrate to the desired form, it is possible to suppress increases in production costs in comparison to, for example, a case of forming the outer periphery portion to the desired form by a separate step after molding.

A third aspect of the present invention is an optical disc which includes: an optical disc substrate fabricated by the optical disc substrate fabrication method of the first or second aspect; and a thin film-form cover sheet which is laminated to the information recording surface of the optical disc substrate for protecting the information recording surface.

In the third aspect of the present invention, the optical disc is structured by laminating the thin film-form cover sheet for protecting the information recording surface onto the information recording surface of the optical disc substrate that has been fabricated by the optical disc substrate fabrication method described above. Thus, the problem of residual bubbles being formed when the cover sheet is laminated on the optical disc substrate is eliminated, and product quality can be improved.

Because the optical disc substrate fabrication method of the present invention is the method described above, when a cover sheet is laminated onto an information recording surface of the optical disc substrate, residual bubbles are not formed between the cover sheet and the information recording surface. Moreover, because the optical disc of the present invention employs an optical disc substrate fabricated by the optical disc substrate fabrication method described above, the problem of residual bubbles occurring between the optical disc substrate and the cover sheet can be eliminated and product quality can be improved.

### BRIEF DESCRIPTION OF THE DRAWINGS

FIG. 1 is a perspective view showing structure of an optical disc relating to an embodiment of the present invention.

FIG. 2A is a sectional view showing structure of a mold for molding a disc substrate relating to the embodiment of the present invention.

FIG. 2B is an enlarged sectional view showing an outer periphery portion vicinity of FIG. 2A.

FIG. 3 is a plan view showing structure of an optical disc fabrication apparatus relating to the embodiment of the present invention.

FIG. 4A is a perspective view showing a punching apparatus of a sheet supply unit shown in FIG. 3.

FIG. 4B is a side view showing structure of a laminated sheet material from which cover sheets are punched by the punching apparatus.

FIG. 5 is a side view showing structures of a sheet-peeling apparatus and a lamination unit of the optical disc fabrication apparatus shown in FIG. 3.

FIG. 6 is a plan view showing the structures of the sheet-peeling apparatus and the lamination unit of the optical disc fabrication apparatus shown in FIG. 3.

FIG. 7 shows a state just after a sheet transport stand shown in FIG. 6 starts to move from a receiving position toward a position of commencement of lamination of a cover sheet.

FIG. 8 shows a state when the sheet transport stand shown in FIG. 6 has moved to the position of commencement of lamination of the cover sheet.

FIG. 9 shows a state just before lamination of the cover sheet onto the disc substrate by the sheet transport stand shown in FIG. 6 finishes.

FIG. 10 is an enlarged sectional view showing an outer periphery portion vicinity of the optical disc relating to the embodiment of the present invention.

FIG. 11A is a descriptive view for explaining various dimensions of the outer periphery portion vicinity of the disc substrate.

FIG. 11B is a table showing evaluation results of product appearance quality inspections with regard to residual bubbles at optical discs which are fabricated using disc substrates with differing height dimensions of outer periphery portions.

FIG. 12A is a sectional view showing structure of a mold for conventional disc substrate molding.

FIG. 12B is an enlarged sectional view showing an outer periphery portion vicinity of FIG. 12A.

FIG. 13 is an enlarged sectional view showing an outer periphery portion vicinity of a conventional optical disc.

### DETAILED DESCRIPTION OF THE INVENTION

Below, an optical disc and an optical disc fabrication apparatus relating to an embodiment of the present invention will be described with reference to the drawings.

Structure of Optical Disc

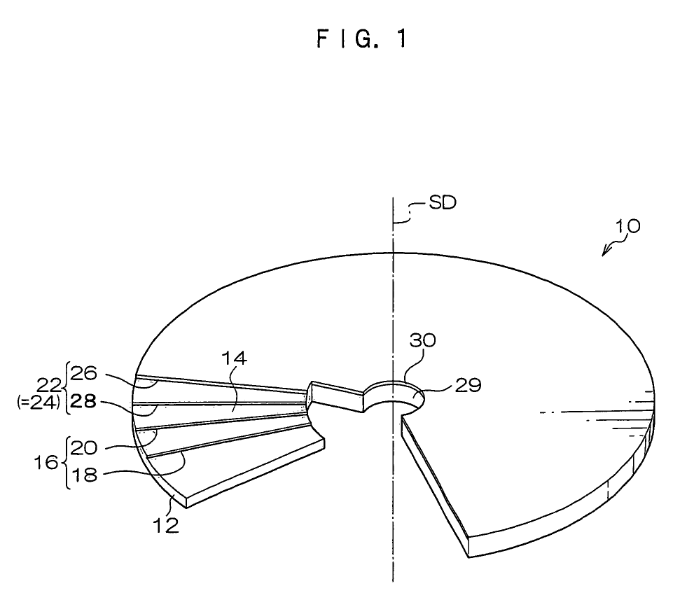

First, structure of the optical disc relating to the embodiment of the present invention will be described. FIG. 1 shows an optical disc 10 relating to the embodiment of the present invention. This optical disc 10 is a disc at which information recording is possible at higher densities than on conventional optical discs such as DVD-Rs and the like. For example, in contrast to a conventional optical disc, short-wavelength blue-violet laser light is used as laser light for recording and replaying, and the aperture number NA of an object lens of a disc drive device is increased to around 0.85. Thus, the recording capacity on one side of the optical disc 10, with diameter 120 mm, is raised to 25 gigabytes or more.

The optical disc 10 is provided with a disc substrate 12, which is formed in a circular plate shape. A surface of one side of this disc substrate 12 serves as an information recording surface 14. A light reflection layer 18 and a light absorption layer 20 are laminated in this order at the recording surface 14 side of the disc substrate 12. An information recording layer (below referred to simply as “the recording layer”) 16 is structured by the light reflection layer 18 and the light absorption layer 20. A transparent cover layer 22 is also provided on the optical disc 10. The cover layer 22 is provided on the disc substrate 12 so as to cover the recording layer 16. This cover layer 22 is structured by a cover sheet 24, whose base material is a transparent resin. Thickness of the cover sheet 24 is around 100 μm.

The disc substrate 12 is formed by molding, with a resin such as PC (polycarbonate) or the like as the base material thereof. The cover sheet 24 structuring the cover layer 22 is formed of a transparent resin film 26 and an adhesive film 28. The resin film 26 is formed of PC (polycarbonate), PET (polyethylene terephthalate) or the like. The adhesive film 28 is formed at the surface of one side of the resin film 26. The adhesive film 28 is formed of an adhesive such as a known acrylic, rubber, silicone or the like. Acrylic adhesives are desirable with regard to transparency and durability.

A circular center hole 29 is formed through a central portion of the disc substrate 12, along an axis SD which is a center of rotation of the optical disc 10. A circular opening portion 30 is formed at a central portion of the cover layer 22. The opening portion 30 is centered on the axis SD and has substantially the same diameter as the center hole 29. However, it is sufficient if an inner peripheral end of the cover layer 22 is disposed to an inner peripheral side relative to the recording layer 16 of the disc substrate 12. Therefore, the internal diameter of the opening portion 30 may be made larger than the internal diameter of the center hole 29 within a range which satisfies this positional relationship.

Next, a mold for disc substrate-molding, which molds the disc substrate 12 in the above-described optical disc 10 of the present embodiment, and an optical disc fabrication apparatus, which employs the disc substrate 12 molded by this mold to fabricate the optical disc 10, will be described.

Structure of Mold for Disc Substrate-Molding

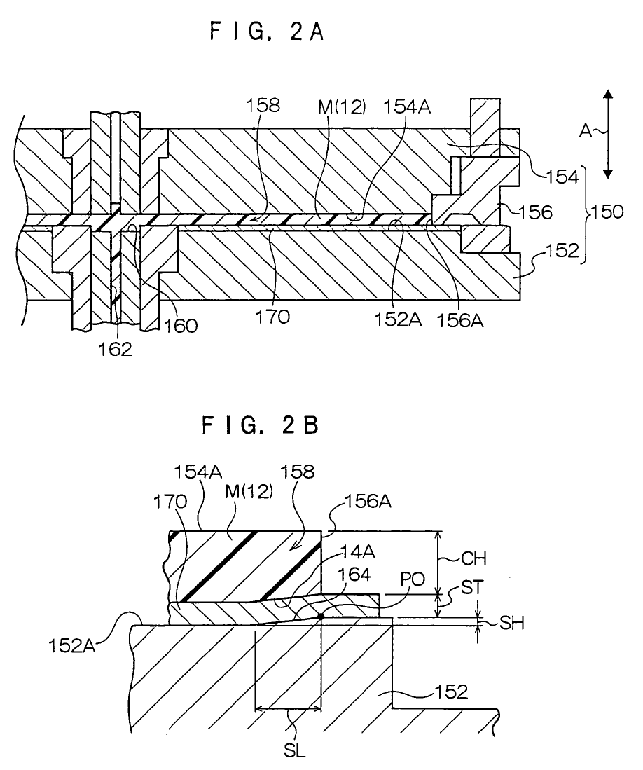

FIGS. 2A and 2B show a mold 150 (a die) for disc substrate-molding relating to the embodiment of the present invention. The mold 150 is provided with a separately structured fixed mold 152 and movable mold 154. A stamper holder (cavity ring) 156 is provided at an outer peripheral end portion of the movable mold 154.

As shown in FIG. 2A, in a state in which the fixed mold 152 and the movable mold 154 are clamped, a cavity 158 which forms the shape of a molded product, i.e., the disc substrate 12, is structured by the fixed mold 152, the movable mold 154 and the stamper holder 156.

The cavity 158 is a circular plate-shaped space with a predetermined height (thickness) dimension. A molding surface which indirectly, via a stamper 170 which is described later, molds a front face side of the disc substrate 12 (the recording surface 14 side thereof) is structured by a mold face 152A at the fixed mold 152 side. A molding surface which directly molds a rear face side of the disc substrate 12 is structured by a mold face 154A at the movable mold 154 side. A molding surface which directly molds a circumferential end face of the disc substrate 12 is structured by a mold face 156A of the stamper holder 156.

A direct gate 160, which communicates with a runner 162, is formed at a center of the cavity 158. An end of this runner 162 is connected with a nozzle of an injection device via a conically formed sprue (none of this structure is shown in the drawing). A molten resin (molding material) M, which is the material of the disc substrate 12, is ejected from the injection device, through the runner 162 and the direct gate 160, into the cavity 158.

As shown in FIG. 2B, the fixed mold 152 is provided with an angled surface portion 164 at an outer periphery portion vicinity of the mold face 152A. The angled surface portion 164 is formed in an annular shape in plan view. A start point of the angled surface portion 164 is at an intersection point P0 where a line extending from the mold face 156A of the stamper holder 156 structuring the cavity 158 intersects with the mold face 152A of the fixed mold 152. The angled surface portion 164 is provided in a range defined by a dimension SL from the intersection point P0 toward an inner side (center side) of the mold face 152A. As shown in the drawing, in the range of the dimension SL, the angled surface portion 164 is formed at an angle with an upward gradient from the inner side toward the outer side, rising by a dimension SH from the mold face 152A.

The angled surface portion 164 of the present embodiment is set to SL 0.8 mm and SH=0.01 mm. Furthermore, in the present embodiment, a thickness dimension ST of the stamper 170 is set to ST=0.3 mm and a height dimension CH of an outer peripheral end face of the cavity 158, which is structured by the mold face 156A of the stamper holder 156, is set to CH=1.1 mm.

Meanwhile, the movable mold 154 is structured so as to be moved in a vertical direction (i.e., the direction of arrow A in FIG. 2A) by an unillustrated hydraulic cylinder. Clamping pressure is regulated by a controller which controls this hydraulic cylinder.

Structure of Optical Disc Fabrication apparatus

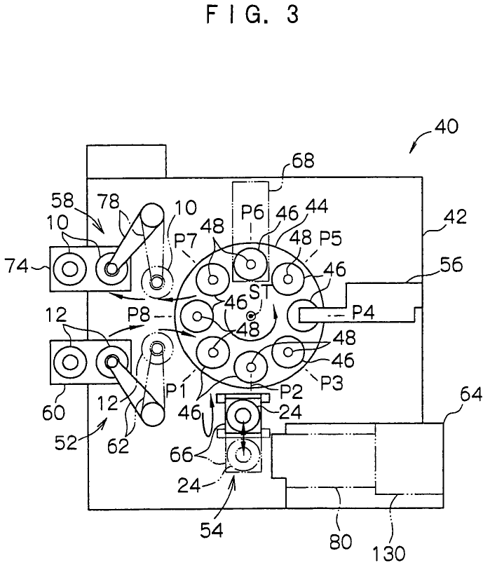

FIG. 3 shows the optical disc fabrication apparatus relating to the embodiment of the present invention. This optical disc fabrication apparatus 40 is a apparatus for fabricating the optical disc 10 by laminating the cover sheet 24 onto the disc substrate 12 that has been molded by mold-forming or the like. In the optical disc fabrication apparatus 40, the disc substrate 12 and the cover sheet 24, which have been fabricated by undergoing respective separate processes, are supplied to an optical disc production line.

The optical disc fabrication apparatus 40 is provided with a main body casing 42, which accommodates a control unit (not shown) and the like. A circular plate-form turntable 44, centered on an axial center ST, is rotatably disposed at a central vicinity of an upper face portion of this main body casing 42. Eight disc support pedestals 46 are provided on this turntable 44, along a circumferential direction around the axial center ST. The disc substrates 12 can be loaded on the disc support pedestals 46. Each of these disc support pedestals 46 is provided, at a central portion of the disc support pedestal 46, with a center pin 48 which corresponds with the center hole 29 of the disc substrate 12. A protrusion length of the center pin 48 from an upper face portion of the disc support pedestal 46 is adjustable. When the disc substrate 12 is placed on the disc support pedestal 46, the center pin 48 protrudes from the disc support pedestal 46, fits into the center hole 29 of the disc substrate 12, and positions the disc substrate 12 at a central position on the disc support pedestal 46.

Numerous suction holes (not shown) open in the upper face portion of the disc support pedestal 46. These suction holes are respectively connected to a vacuum generation device such as a vacuum pump or the like. When the disc substrate 12 is placed on the disc support pedestal 46, this vacuum generation device supplies negative pressure to the suction holes of the disc support pedestal 46. As a result, the disc substrate 12 is suction-adhered to the upper face portion of the disc support pedestal 46 by the action of the negative pressure in the suction holes.

As shown in FIG. 3, the optical disc fabrication apparatus 40 is provided, at an outer peripheral side of the turntable 44, with a disc supply unit 52, a lamination unit 54, a peeling unit 56, a surface form inspection unit 68 and a disc ejection unit 58. In FIG. 3, taking the disc support pedestal 46 that is at a position for receiving supply of the disc substrates 12 from the disc supply unit 52 as a start point, positions (circumferential positions) at which the eight disc support pedestals 46 are respectively retained along a direction of rotation of the turntable 44 (the anti-clockwise direction) are shown as P1 to P8.

The disc supply unit 52 is disposed at an outer peripheral vicinity of the circumferential position P1. The disc supply unit 52 is provided with a disc stand 60 and a transport arm 62. A plurality of the disc substrates 12 can be stacked on the sheet supply unit 64. The transport arm 62 grabs one of the disc substrates 12 from the plurality of disc substrates 12 stacked on the disc stand 60 and transports the single disc substrate 12 onto the disc support pedestal 46 that is at the circumferential position P1.

The lamination unit 54 is an apparatus for laminating the cover sheets 24 to the disc substrates 12 that have been placed on the disc support pedestals 46. The lamination unit 54 is disposed at an outer peripheral side of the circumferential position P2. The optical disc fabrication apparatus 40 is provided with a sheet supply unit 64, which is for supplying the cover sheets 24 sideways to the lamination unit 54. Herein, the lamination unit 54 is provided with a sheet transport stand 66, which retains the cover sheet 24 that has been supplied by the sheet supply unit 64 and transports this cover sheet 24 to above the disc support pedestal 46 that is retained at the circumferential position P1. This sheet transport stand 66 is made to be movable between a receiving position, for receiving the cover sheet 24 supplied from the sheet supply unit 64 (a position shown by solid lines in FIG. 3), and the circumferential position P2.

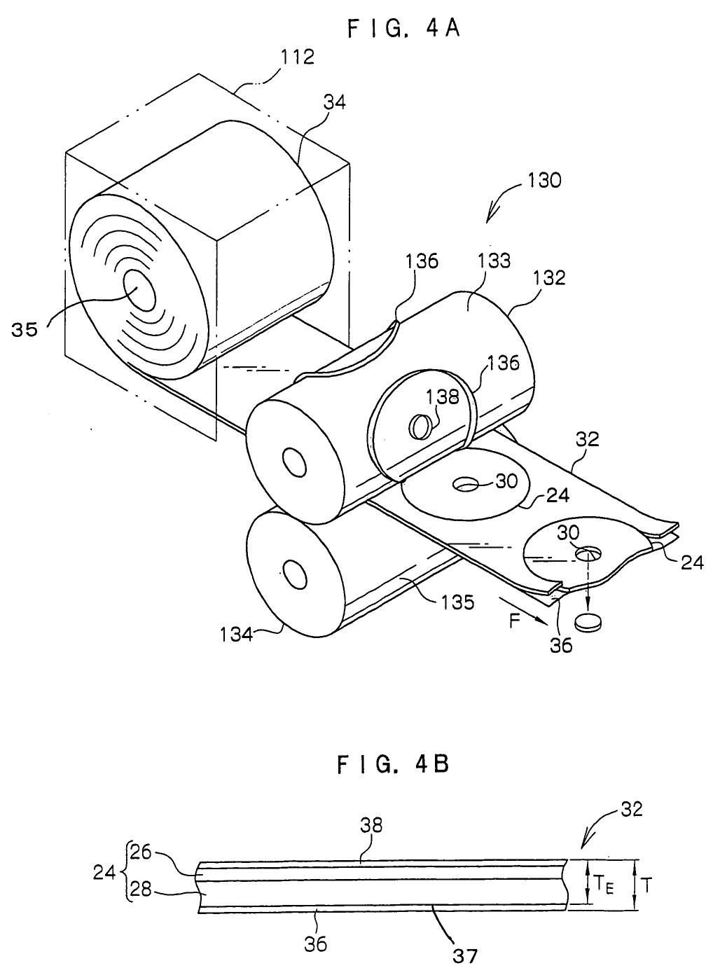

As shown in FIG. 3, the peeling unit 56 is disposed upward of the disc support pedestal 46 that is retained at the circumferential position P4. The peeling unit 56 peels off a protective sheet 38 (see FIG. 4B), which has been adhered onto an upper face (a light incidence face) of the optical disc 10 placed on the disc support pedestal 46 that is retained at this circumferential position P4, and recovers this protective sheet 38. Further, the surface form inspection unit 68 is disposed upward of the disc support pedestal 46 that is retained at the circumferential position P6. The surface form inspection unit 68 inspects flatness of the light incidence surface of the optical disc 10 placed on the disc support pedestal 46 retained at the circumferential position P6, a tilt amount of the same with reference to the axial center SD, and so forth. Results of inspection of the optical disc 10 by the surface form inspection unit 68 are transmitted to the (unillustrated) control unit of the optical disc fabrication apparatus 40. On the basis of the results of inspection by the surface form inspection unit 68, the control unit predetermines whether the optical disc 10 that has been transported to the circumferential position P7 is an unsatisfactory product, which does not meet product quality standards, or a satisfactory product which meets the product quality standards.

The disc ejection unit 58 is disposed at an outer peripheral vicinity of the disc support pedestal 46 that is retained at the circumferential position P7. The disc ejection unit 58 is provided with a disc stand 74 and is provided with a transport arm 78. A plurality of the disc substrates 12 can be respectively stacked at the disc stand 74. The transport arm 78 is for transporting the optical disc 10 between the disc support pedestal 46 retained at the circumferential position P7 and the disc stand 74.

Next, the sheet supply unit 64 and the lamination unit 54 of the optical disc fabrication apparatus 40 described above will be described in more detail.

As shown in FIG. 4A, the sheet supply unit 64 is provided with a punching apparatus 130, which produces the cover sheets 24 by performing a cutting process (punching process) on a laminated sheet material 32, which is a processing material of the cover sheet 24. Herein, as shown in FIG. 4B, the laminated sheet material 32 has a four-layer structure formed of the resin film 26, the adhesive film 28, a peeling sheet 36 and the protective sheet 38. The adhesive film 28 is formed as a film on one side face of the resin film 26, the peeling sheet 36 is adhered onto a surface of the adhesive film 28, and the protective sheet 38 is adhered onto a face of the resin film 26 at a side thereof opposite to the side thereof at which the adhesive film 28 is provided. The peeling sheet 36 and the protective sheet 38 are each formed as a thin film whose base material is a resin such as PET or the like. The peeling sheet 36 and the protective sheet 38 are peelably adhered onto the adhesive film 28 and the resin film 26, respectively.

As shown in FIG. 4A, the laminated sheet material 32 is formed in a long band form, is wound up in a roll form to serve as a sheet roll 34 and is loaded into a feeding section 112 of the punching apparatus 130. This laminated sheet material 32 has a constant tendency to curl along the length direction thereof so as to curve, in a recessed form, toward the side of a winding core 35 of the sheet roll 34. Strength of this curling tendency of the laminated sheet material 32 is weak for the laminated sheet material 32 that has been wound round at an outer peripheral side of the sheet roll 34, but becomes stronger the closer a winding position was to an inner peripheral side of the sheet roll 34. That is, the laminated sheet material 32 tends to curve with greater force for smaller diameters of curvature.

The feeding section 112 of the punching apparatus 130 rotatably supports the sheet roll 34 and feeds out the laminated sheet material 32 from the sheet roll 34 to a downstream side. As shown in FIG. 4A, the punching apparatus 130 is provided, along a transport path of the laminated sheet material 32, with a blade roller 132 and an anvil 134, which act together as a pair. At a roller surface 133 of the blade roller 132, pluralities (for example, threes) of outer periphery punching blades 136 and inner periphery punching blades 138 are provided along a circumferential direction of the roller surface 133. The outer periphery punching blades 136 and inner periphery punching blades 138 are provided in concentric arrangements. The anvil 134 is disposed at a lower side of the blade roller 132 so as to be axially parallel with the blade roller 132. These rollers 132 and 134 are each subjected to torque from a roller driving section (not shown) and rotate with a matching linear speed.

The outer periphery punching blades 136 of the blade roller 132 are provided in annular forms on the roller surface 133. The outer periphery punching blades 136 are formed such that, if flattened out in plan view, blade tip portions thereof would extend along circular loci with diameters substantially the same as or slightly smaller than the disc substrates 12. A protrusion length of the outer periphery punching blades 136 from the roller surface 133 is set to be equal to a thickness TE, from a surface of the protective sheet 38 at the laminated sheet material 32 to an adhesion surface 37 of the peeling sheet 36 (see FIG. 4B), or to be slightly longer than the thickness TE. Consequently, the blade tips of the outer periphery punching blades 136 reach as far as an intermediate point along the thickness direction of the peeling sheet 36, can absorb a degree of resilient deformation of the laminated sheet material 32 and can reliably cut the protective sheet 38 and the resin film 26.

The inner periphery punching blades 138 of the blade roller 132 are also provided in annular forms on the roller surface 133 and are formed such that, if flattened out in plan view, blade tip portions thereof extend along circular loci with substantially the same diameter as the opening portions 30 of the cover sheets 24 (see FIG. 1). Further, the protrusion lengths of the inner periphery punching blades 138 from the roller surface 133 are set to be substantially equal to an overall thickness T of the laminated sheet material 32 (see FIG. 4B).

A roller surface 135 of the anvil 134 is constituted by a curved surface whose radius of curvature from the axial center of the anvil 134 is constant. The roller surface 135 is formed of a material featuring hardness and abrasion resistance of at least certain values, such as a metal, a hard resin or the like. Here, the anvil 134 is urged with a predetermined urging force in a direction toward the blade roller 132 by an urging mechanism (not shown).

In the punching apparatus 130, the laminated sheet material 32 that has been wound out to the downstream side by the feeding section 112 is nipped between the blade roller 132 and the anvil 134. The blade roller 132 and the anvil 134 rotate with the common linear speed and feed the laminated sheet material 32 out to the downstream side thereof. Here, because the anvil 134 is urged by the urging mechanism, the laminated sheet material 32 is pressed (compressed) between the roller surface 133 of the blade roller 132 and the roller surface 135 of the anvil 134 while being transported in a transport direction (the direction of arrow F) at a constant speed by conveyance force from the rollers 132 and 134. During conveyance of the laminated sheet material 32 by these rollers 132 and 134, the blade roller 132 presses the roller surface 133 thereof against the surface of the protective sheet 38 and the anvil 134 presses the roller surface 135 thereof against the surface of the peeling sheet 36.

The blade roller 132, together with the anvil 134, transports the laminated sheet material 32 in the conveyance direction while the outer periphery punching blades 136 press against the protective sheet 38 of the laminated sheet material 32, and the laminated sheet material 32 is cut by the outer periphery punching blades 136 and the inner periphery punching blades 138. At this time, because the protrusion lengths of the outer periphery punching blades 136 from the roller surface 133 are of a length equal to the thickness TE of the laminated sheet material 32 (see FIG. 4B) or slightly longer than the thickness TE, the outer periphery punching blades 136 pass through the protective sheet 38 of the laminated sheet material 32 and the resin film 26, at one side of which the adhesive film 28 is formed, but do not pass through the peeling sheet 36. As a result, of the protective sheet 38 and the resin film 26 of the laminated sheet material 32 that has passed between the rollers 132 and 134, regions that are at inner peripheral sides of the outer periphery punching blades 136 are cut to circular plate forms, and are cut away from other regions of the protective sheet 38 and the resin film 26. Meanwhile, the peeling sheet 36 of the laminated sheet material 32 that has passed between the rollers 132 and 134 is not cut by the punching blades 136 and 138 but is fed out in the transport direction in its original long band form.

Further, because the protrusion lengths of the inner periphery punching blades 138 from the roller surface 133 are set equal to the thickness T of the laminated sheet material 32 (see FIG. 4B) or slightly shorter than the thickness T, the inner periphery punching blades 138 pass all the way through the laminated sheet material 32 and form circular through-holes through central portions of the regions that are punched out by the outer periphery punching blades 136. Hence, the resin film 26 and adhesive film 28 that have been punched out in circular plate forms by the outer periphery punching blades 136 serve as the cover sheets 24 that are to be laminated onto the disc substrates 12, and the through-holes of the resin film 26 and adhesive film 28 that have been punched out by the inner periphery punching blades 138 serve as the opening portions 30 of the cover sheets 24. These cover sheets 24 are fed out in the transport direction in a state in which the peeling sheet 36, which has been punched by the outer periphery punching blades 136 and the inner periphery punching blades 138 and has the same surface form as the cover sheets 24, is still adhered thereto.

Next at the punching apparatus 130, portions of the adhesive film 28 and the resin film 26 at outer peripheral sides of the cover sheets 24 are peeled from the laminated sheet material 32 that has passed between the blade roller 132 and the anvil 134 and are discarded. At the same time, portions at inner peripheral sides of the opening portions 30 of the laminated sheet material 32 are removed and discarded. Thus, production of the cover sheet 24 is completed, the peeling sheet 36 is still adhered in its original long belt form to the adhesive film 28 of the cover sheet 24, and the protective sheet 38, which has been formed to substantially the same surface form as the cover sheet 24, is still adhered to the resin film 26.

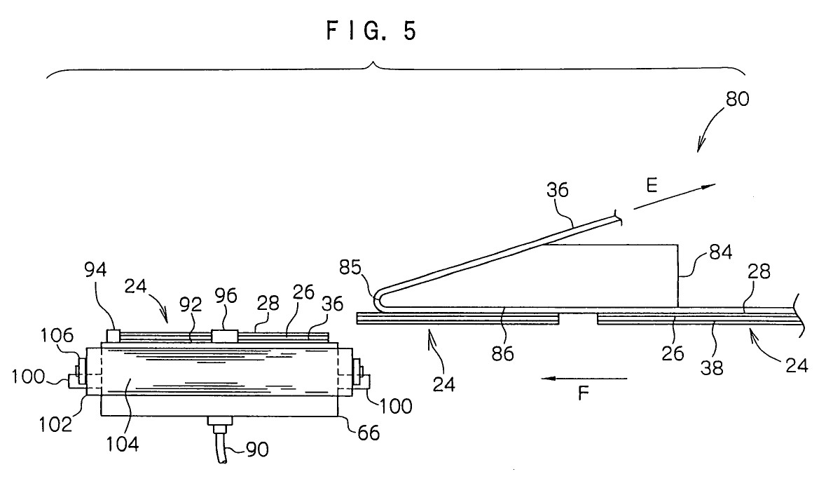

At the sheet supply unit 64, the cover sheet 24 is peeled from the peeling sheet 36. A sheet-peeling apparatus 80, for peeling the cover sheet 24 from the peeling sheet 36 and for transporting the cover sheet 24 onto the sheet transport stand 66 of the lamination unit 54, is provided at a downstream side of the punching apparatus 130. As shown in FIG. 5, a wedge-like peeling guide member 84 is provided at the sheet-peeling apparatus 80. The peeling guide member 84 is for peeling the cover sheet 24 from the long belt-form peeling sheet 36 while transferring the cover sheet 24 onto the sheet transport stand 66 of the lamination unit 54. The peeling guide member 84 is supported such that a distal end portion 85 thereof is oriented toward the sheet transport stand 66 of the lamination unit 54, which is at the receiving position.

At the sheet-peeling apparatus 80, at a downstream side of the peeling guide member 84, the plurality of cover sheets 24 applies a predetermined tension to the peeling sheet 36 that is adhered to lower face sides thereof, and a tension mechanism (not shown) is provided which applies a predetermined tensile force to the peeling sheet 36 in a peeling direction (the direction of arrow E). As a result, at the sheet-peeling apparatus 80, the cover sheet 24 presses against a lower face portion 86 of the peeling guide member 84, via the peeling sheet 36, with a predetermined pressing force while the cover sheet 24 moves from a base end side toward the distal end side of the peeling guide member 84. Then, the cover sheet 24 peels off from the peeling sheet 36 in a vicinity of the distal end portion 85 of the peeling guide member 84. Further, the cover sheet 24 that has peeled off from the peeling sheet 36 is pushed out to a forward side of the peeling guide member 84 and slides on to the sheet transport stand 66, which is being retained at the illustrated receiving position. This cover sheet 24 has a tendency to curl such that an upper face side thereof curves in a recessed form along the direction of conveyance by the sheet-peeling apparatus 80 (the direction of arrow F).

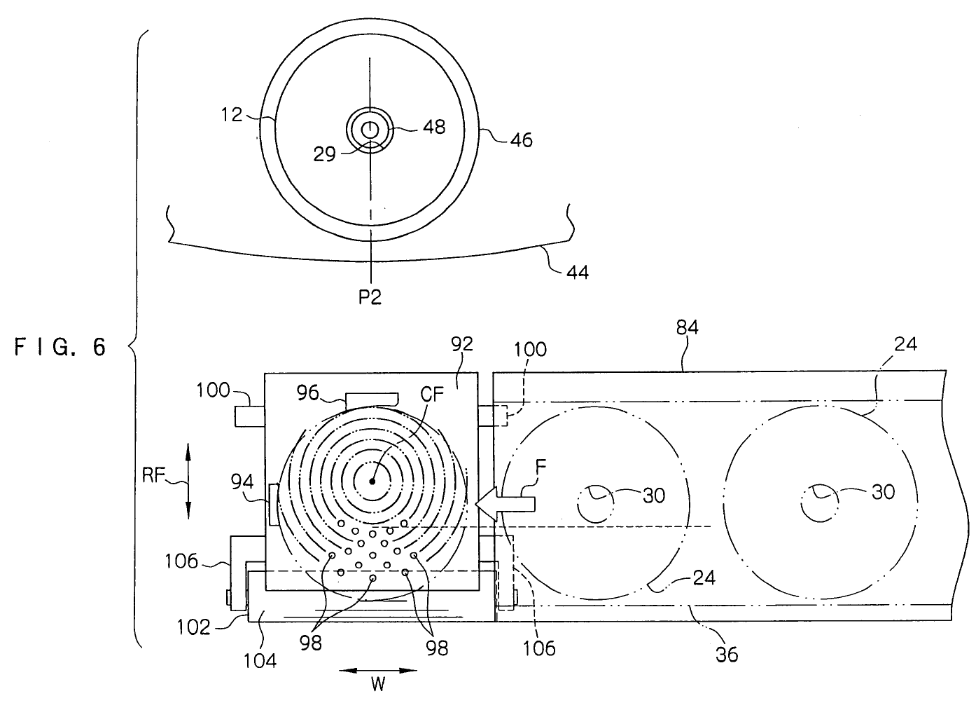

As is shown in FIGS. 5 and 6, an upper face portion of the sheet transport stand 66 of the lamination unit 54 is formed as a flat-faced sheet placing face 92. A block-form stopper member 94 is provided at a far end portion of the sheet placing face 92 with respect to the direction of conveyance of the cover sheet 24 by the sheet supply unit 64 (i.e., the direction of arrow F), and a block-form guide member 96 is provided at a side end portion at a turntable 44 side of the sheet placing face 92. The guide member 96 abuts against an outer peripheral end of the cover sheet 24 that has been slid onto the sheet placing face 92 from the peeling guide member 84, and prevents shifting of this cover sheet 24. The stopper member 94 also abuts against the outer peripheral end of the cover sheet 24 that has been, slid onto the sheet placing face 92 from the peeling guide member 84 and, together with the guide member 96, positions the cover sheet 24 at a predetermined placing position of the sheet placing face 92. Hence, an end portion of the cover sheet 24 at a side opposite to the side thereof at which the turntable 44 is disposed (one end portion of the cover sheet 24) protrudes to the peeling guide member 84 side from the sheet placing face 92, as shown by a broken line in FIG. 6.

At an interior portion of the sheet transport stand 66, a negative pressure chamber (not shown) is provided at a lower portion side of the sheet placing face 92 so as to oppose the sheet placing face 92. Numerous suction holes 98 (see FIG. 6) are formed to pass through from this negative pressure chamber to the sheet placing face 92. The negative pressure chamber of the sheet transport stand 66 is connected to a vacuum generation device, such as a vacuum pump or the like, through a pressure pipe 90 (see FIG. 5), which is formed of a flexible hose or the like. When the cover sheet 24 is placed on the sheet placing face 92 and positioned at the placing position, this vacuum generation device sucks in air from the negative pressure chamber and reduces pressure in the negative pressure chamber to a pre-specified level of vacuum. As a result, the cover sheet 24 is suction-adhered on the sheet placing face 92 by the action of the negative pressure through the suction holes 98. Hence, even if the cover sheet 24 has a strong curling tendency, the whole of the cover sheet 24 is in a state which is assuredly suction-adhered to the sheet placing face 92. Note that for the sheet placing face 92 shown in FIG. 6, in order to simplify the drawing, only some of the suction holes 98 are shown, and a region, at which the suction holes 98 that are not shown in the drawing are provided, is represented by broken lines.

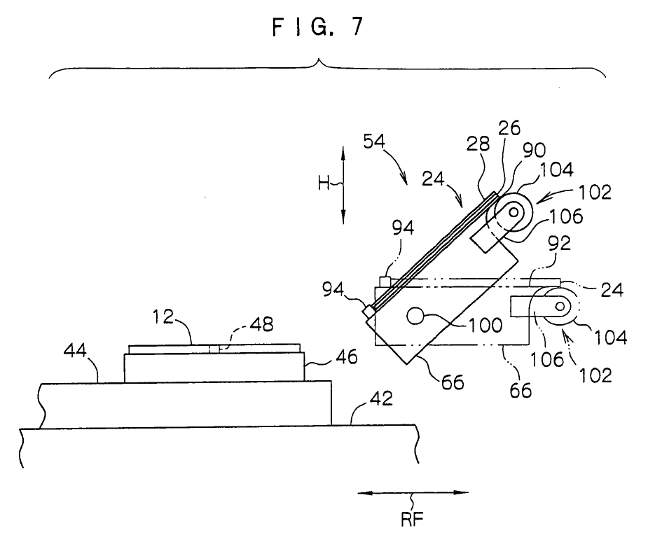

As shown in FIGS. 6 and 7, inversion axes 100 are provided at two side face portions of the sheet transport stand 66, respectively protruding in a width direction of the sheet placing face 92 (the direction of arrow W in FIG. 6). A transport and pressing mechanism (not shown) is provided at the lamination unit 54. The transport and pressing mechanism inverts the sheet transport stand 66 around the inversion axes 100 and moves the sheet transport stand 66 along a vertical direction (the direction of arrow H in FIG. 7) and a curl rectification direction (the direction of arrow RF), which is parallel to the radial direction of the turntable 44. Herein, the curl rectification direction is perpendicular to the direction of transport of the cover sheet 24 by the sheet supply unit 64. At the sheet transport stand 66, a cylindrical pressure roller 102 is rotatably mounted to the sheet transport stand 66 by a bracket 106 so as to be axially parallel with the inversion axes 100. A surface layer portion along a roller surface 104 of this pressure roller 102 is formed of a resilient material such as silicone rubber, urethane rubber, VITON or the like, and a dimension of this roller surface 104 along the axial direction of the pressure roller 102 is set to be longer than the diameter of the cover sheet 24.

As shown in FIG. 7, in the state in which the sheet transport stand 66 is at the receiving position, the pressure roller 102 is at an outer peripheral side of the sheet transport stand 66 with respect to the curl rectification direction, and is axially supported so as to be disposed slightly to the lower side relative to the sheet placing face 92. Accordingly, when the cover sheet 24 is placed on the sheet transport stand 66 at the receiving position, the roller surface 104 of the pressure roller 102 is opposed with the one end portion of the cover sheet 24, which protrudes to an upstream side from the sheet placing face 92.

When the cover sheet 24 has been suction-adhered onto the sheet placing face 92 by the negative pressure, the transport and pressing mechanism of the lamination unit 54 starts to move the sheet transport stand 66 toward the inner peripheral side in the curl rectification direction. At this time, as shown in FIG. 7, the transport and processing mechanism first, while turning the sheet transport stand 66 over in a predetermined direction (the anti-clockwise direction in FIG. 7) about the inversion axes 100, lifts the sheet transport stand 66 until the sheet transport stand 66 is upward of the disc support pedestal 46 of the turntable 44. Then, while the transport and pressing mechanism continues the operation of inversion of the sheet transport stand 66, the transport and pressing mechanism moves the sheet transport stand 66 to a predetermined lamination commencement position over the disc support pedestal 46 that is retained at the circumferential position P2.

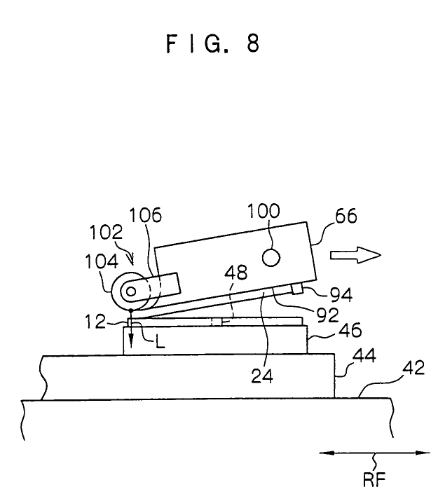

As shown in FIG. 8, the sheet transport stand 66 that has moved to the lamination commencement position superposes the one end portion of the cover sheet 24 extending from the sheet placing face 92 with one end portion of the disc substrate 12 that has been placed on the disc support pedestal 46, and presses the roller surface 104 of the pressure roller 102 against the one end portion of the cover sheet 24 with a predetermined load value L. In consequence, the one end portion of the cover sheet 24 is pressed against the one end portion of the disc substrate 12. Here, the load value L is specified basically in accordance with the magnitude of a pressure force that is required for laminating the cover sheet 24 onto the disc substrate 12. Moreover, when the load value L is specified thus, a friction force of the pressure roller 102 against the cover sheet 24 is significantly greater than a suction force on the cover sheet 24 from the suction holes 98 of the sheet placing face 92.

Next, the transport and pressing mechanism presses the pressure roller 102 against the cover sheet 24 with the load value L, while moving the sheet transport stand 66 along the curl rectification direction from the lamination commencement position toward the outer peripheral side. As a result, the cover sheet 24 slides relatively toward the inner peripheral side of the turntable 44 from the sheet placing face 92 of the sheet transport stand 66, and a portion of the cover sheet 24 that has been fed out to the inner peripheral side from the sheet placing face 92 is progressively pressed onto the disc substrate 12 by the pressure roller 102 with a pressure force corresponding to the load value L. Herein, the load value L of the pressure roller 102 is set in a range of 0.08 to 2.5 N/cm, and a speed of movement of the pressure roller 102 is set in a range of 1.2 to 120 cm/s.

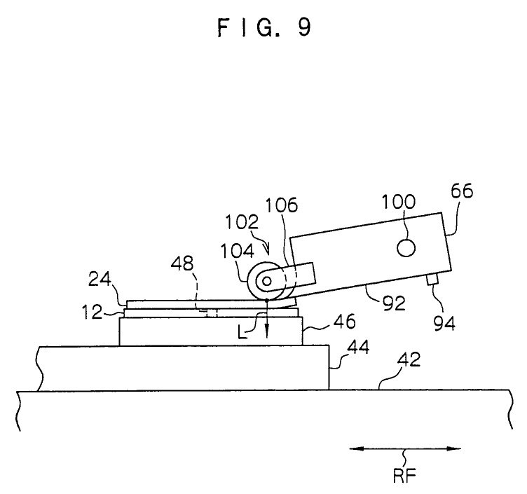

When the sheet transport stand 66 moves along the curl rectification direction from the lamination commencement position toward the outer peripheral side, the pressure roller 102 moves toward the outer peripheral side with the sheet transport stand 66, rolling over the cover sheet 24. As a result, as shown in FIG. 9, the cover sheet 24 proceeds to be laminated onto the disc substrate 12, from the one end portion of the cover sheet 24 toward another end portion thereof, by the pressure force from the pressure roller 102. Substantially at the moment that the pressure roller 102 leaves the outer peripheral side of the disc substrate 12, the lamination of the cover sheet 24 onto the disc substrate 12 is completed and the optical disc 10 has been fabricated as a basic manufactured item. At this time, because the pressure roller 102 presses against the cover sheet 24 while rolling over the cover sheet 24 in the curl rectification direction which substantially intersects the direction of winding of the cover sheet 24 in the sheet roll 34, compression strain and shearing strain are both applied along the curl rectification direction to the cover sheet 24 that is being laminated onto the disc substrate 12. Subsequently, the transport and pressing mechanism returns the sheet transport stand 66, which has moved away to the outer peripheral side of the disc substrate 12, to the receiving position (see FIG. 5).

Operation of the Embodiment

Next, a fabrication process for producing the disc substrate 12 by injection-molding using the mold 150 that is structured as described above will be described.

In injection-molding of the disc substrate 12 (an injection-molding process), as shown in FIGS. 2A and 2B, the stamper 170, which is a metallic master for replication, is disposed and positioned on the mold face 152A of the fixed mold 152.

First, the hydraulic cylinder is controlled by the controller to move the movable mold 154 upward and separate the movable mold 154 from the fixed mold 152. In this state, the stamper 170 is placed on the mold face 152A of the fixed mold 152 with a plate surface at which grooves for transcription are formed (a transcription surface) oriented upward. Here, the grooves are formed at the transcription surface in a spiral manner.

Next, the movable mold 154 is moved downward and is clamped to the fixed mold 152 with a predetermined clamping pressure by the hydraulic cylinder. In this clamping, an outer periphery portion vicinity of the stamper 170 is pushed against the mold face 152A of the fixed mold 152 by the stamper holder 156. Consequently, the stamper 170 is fixed at the placing position, a back face thereof closely contacts with the mold face 152A, and a predetermined range of the outer periphery portion vicinity thereof is put into an inclined state with a gradient rising from the inner side toward the outer side along the angled surface portion 164 of the mold face 152A (see FIG. 2B).

Hence, the earlier-described cavity 158 is structured by the clamped fixed mold 152 and movable mold 154, and the stamper holder 156 provided at the movable mold 154. The molten resin M such as PC or the like, which is the material of the disc substrate 12, is charged into the cavity 158 by injection through the runner 162 and direct gate 160 from the injection device, and a basic manufactured product, the disc substrate 12, is formed.

Here, in the present embodiment, an injection temperature is set to around 330° C., a temperature at which the fixed mold 152 is maintained is set to around 118° C. and a temperature at which the movable mold 154 is maintained is set to around 118° C., and the injection-molding is performed under these conditions.

After molding, the movable mold 154 is moved upward and separated from the fixed mold 152, and the molded product formed in a disc shape (a basic production form of the disc substrate 12) is removed. The center hole 29 (see FIG. 1) is formed at a central portion of this molded product and the disc substrate 12, to whose surface (the recording surface 14) the grooves have been transcribed from the stamper 170, is produced.

In the injection-molding process described above, when the molten resin M is injected into the interior of the cavity 158 of the mold 150 from the center of the cavity 158, the molten resin M flows and spreads to the periphery in a radial form while filling in the cavity 158. In the predetermined range (the region of the dimension SL in FIG. 2B) of an area of the cavity 158 that indirectly forms an outer periphery portion 14A of the recording surface 14 side of the disc substrate 12, because of the angled surface portion 164, the outer periphery portion 14A is filled in such that a height dimension thereof becomes gradually smaller from the inner side toward the outer side.

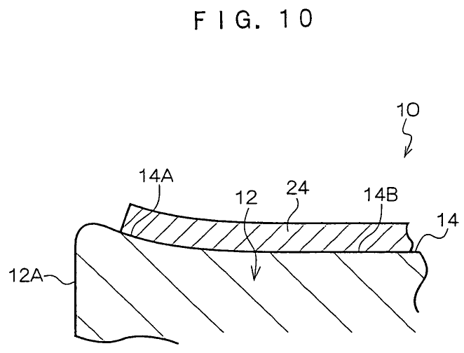

As a result, in the disc substrate 12 that is molded using this mold 150, a difference in relative height dimensions of the outer periphery portion 14A and a center side (a flat face portion 14B), due to a rate of contraction of the outer periphery portion 14A being smaller because the molten resin M thereof, which is charged into the cavity 158 of the mold 150 first, solidifying quicker and a rate of contraction of the flat face portion 14B being larger because the molten resin M thereof, which is charged into the cavity 158 subsequently, solidifying more slowly, is made smaller, as shown in FIG. 10.

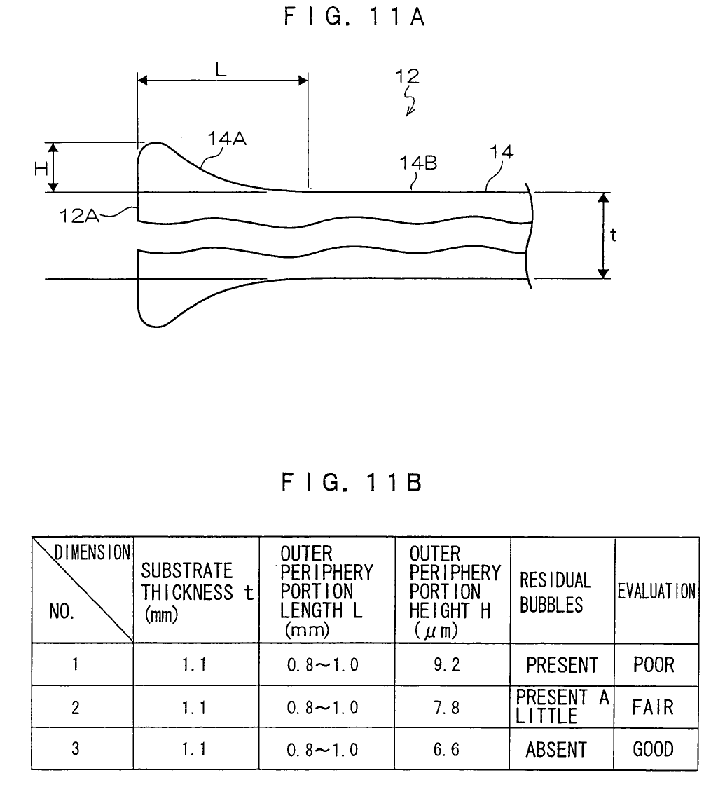

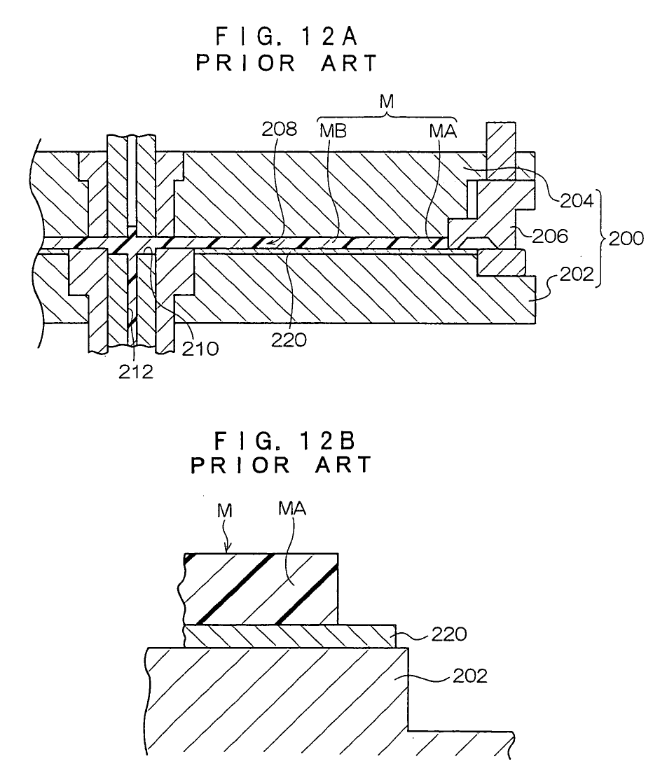

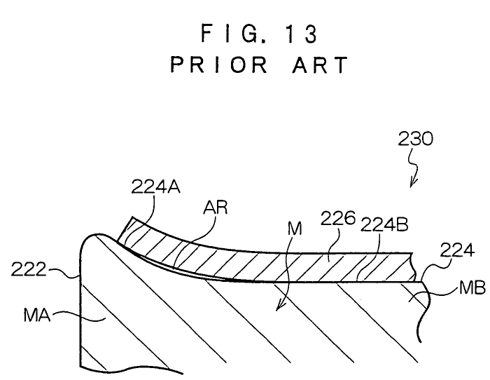

According to results of dimensional measurements of the outer periphery portions 14A of the recording surfaces 14 of the disc substrates 12, which are molded using the mold 150 of the present embodiment, as shown in FIG. 11A, within a range of up to 1 mm (L=1 mm) to the inner side from an outer periphery 12A of the disc substrate 12 along a surface direction of the recording surface 14, all measured samples are formed with relative height dimensions, with respect to the region beyond this 1 mm, within a range of 1 to 7 μm (H=1 to 7 μm).

Next, a fabrication process for fabricating the optical disc 10 using the optical disc fabrication apparatus 40 that is structured as described above will be described.

In the optical disc fabrication apparatus 40, first, one of the disc substrates 12 is grasped from on the disc stand 60 by the transport arm 62 of the disc supply unit 52, and this disc substrate 12 is placed on the disc support pedestal 46 that is at the circumferential position P1 of the turntable 44. At the same time, at the disc support pedestal 46 at the circumferential position P1, the center pin 48 protrudes upward and fits into the center hole 29. Thus, the disc substrate 12 is positioned at the central position on the disc support pedestal 46.

When the disc substrate 12 has been placed on the disc support pedestal 46 by the disc supply unit 52, the turntable 44 rotates in the anti-clockwise direction about the axial center ST and moves the disc support pedestal 46 on which the disc substrate 12 has been placed to the circumferential position P2. Here, one of the cover sheets 24 is placed on the sheet transport stand 66 of the lamination unit 54 by the sheet supply unit 64. As has been previously described, this cover sheet 24 is laminated by the lamination unit 54 onto the recording surface 14 of the disc substrate 12 disposed on the disc support pedestal 46 at the circumferential position P2. Thus, fabrication of the optical disc 10 that is on the disc support pedestal 46 at the circumferential position P2 is completed.

When the fabrication of the optical disc 10 on the disc support pedestal 46 at the circumferential position P2 has been completed, the turntable 44 rotates in the anti-clockwise direction and moves the disc support pedestal 46 on which the optical disc 10 is placed to the circumferential position P4. Synchronously therewith, the peeling unit 56 peels off the protective sheet 38 from the optical disc 10 disposed on the disc support pedestal 46, which is stopped at the circumferential position P4, and recovers the protective sheet 38. Further, the surface form inspection unit 68 inspects surface form, such as flatness, tilt amounts and suchlike of the upper face (the light incidence face) of the optical disc 10 disposed on the disc support pedestal 46, which is at the circumferential position P6. Inspection results from the surface form inspection unit 68 are transmitted to the control unit (not shown) of the optical disc fabrication apparatus 40. On the basis of the results of inspection by the surface form inspection unit 68, the control unit pre-determines whether the optical disc 10 is an unsatisfactory product which does not meet product quality standards or a satisfactory product which does meet product quality standards.

In the optical disc fabrication apparatus 40, after the completion of inspection by the surface form inspection unit 68, when the optical disc 10 has been transported to the circumferential position P7 by the turntable 44, this optical disc 10 is grasped by the transport arm 78 of the disc ejection unit 58, is transported from the disc support pedestal 46 to the disc stand 74 and is stacked on the disc stand 74. At this time, depending on whether the optical disc 10 has been pre-determined to be an unsatisfactory product not meeting product quality standards or a satisfactory product meeting product quality standards, the optical discs 10 may be stacked at different locations on the disc stand 74. When the optical discs 10 that are stacked on the disc stand 74 in this manner have been accumulated to a predetermined lot number, the optical discs 10 are transported from the disc stand 74 to a device for carrying out other processes, such as a reinspection process, a coating process, etc., or the like.

When the optical disc 10 is fabricated by the process described above. In this fabrication process, the disc substrate 12 is fabricated by a fabrication process including the injection-molding process of the present embodiment, the predetermined region of the outer periphery portion 14A of the recording surface 14 has a smaller difference in height dimensions (within the range of 1 to 7 μm) relative to the region beyond this predetermined region. Therefore, when the cover sheet 24 is laminated to the recording surface 14, curvature of an outer periphery portion vicinity of the cover sheet 24, which is laminated onto a vicinity of the outer periphery portion 14A, is made smaller, and a characteristic of close adhesion to the recording surface 14 (the outer periphery portion 14A) at this outer periphery portion vicinity will be excellent. Consequently, as shown in FIG. 10, residual bubbles will not be formed between the disc substrate 12 and the cover sheet 24.

FIG. 11B shows evaluation results when a product quality appearance inspection for residual bubbles was carried out on the optical discs 10 which are fabricated using three disc substrates 12 which have different height dimensions of the outer periphery portion 14A, to evaluate the discs as satisfactory products or unsatisfactory products.

As shown in FIG. 11B, at the disc substrates 12, with a thickness dimension t=1.1 mm, relative differences in height dimensions between a region 0.8 to 1 mm to the inner side along the surface direction of the recording surface 14 from the outer periphery 12A of the disc substrate 12 (L=0.8 to 1 mm) and a region beyond this 0.8 to 1 mm are, respectively, 9.2 μm (No. 1), 7.8 μm (No. 2) and 6.6 μm (No. 3). Of the optical discs 10 No. 1 to No. 3, which are fabricated by laminating the cover sheets 24 onto these disc substrates 12, No. 1 have residual bubbles, No. 2 have slight residual bubbles and No. 3 have no residual bubbles. In evaluation results of product quality appearance inspections thereof, the optical discs 10 of No. 1 and No. 2 are unsatisfactory, and the optical disc 10 of No. 3 is a satisfactory product.

According to the evaluation results described above, when the outer periphery portion 14A of the recording surface 14 of the disc substrate 12 is formed with relative height dimensions in a region up to 1 mm to the inner side along the surface direction of the recording surface 14 from the outer periphery 12A of the disc substrate 12, as compared with the region beyond this 1 mm region, within the range of 1 to 7 μm, at the optical disc 10 that is fabricated with this disc substrate 12, residual bubbles will not occur between the disc substrate 12 and the cover sheet 24, and product quality will be improved.

As has been explained above, with the fabrication method of the disc substrate 12 of the present embodiment, at the disc substrate 12 that structures the optical disc 10, the outer periphery portion 14A of the recording surface 14 of the disc substrate 12 is formed by the injection-molding step of this fabrication process to have relative height dimensions in the region up to 1 mm to the inside along the surface direction of the recording surface 14 from the outer periphery 12A of the disc substrate 12, as compared with the region beyond this 1 mm region, within the 1 to 7 μm range. Therefore, at the optical disc 10 that is fabricated by employing this disc substrate 12, residual bubbles will not occur between the disc substrate 12 and the cover sheet 24, and product quality will be improved.

Furthermore, in the present embodiment, in the injection-molding process described above, the injection-molding is carried out using the mold 150 (the fixed mold 152) which is provided with the cavity 158 and the angled surface portion 164. The cavity 158 molds the disc substrate 12 by the molten resin M that is injected into the interior from the center of the cavity 158 spreading to the circumference and filling the cavity 158. The angled surface portion 164 is provided at the predetermined range of the area of the cavity 158 that will mold the above-described outer periphery portion 14A, and the height dimension of the outer periphery portion 14A gradually decreases from the inner side toward the outer side of the outer periphery portion 14A. Because the injection-molding is carried out using this mold 150, the predetermined region of the outer periphery portion 14A of the recording surface 14 of the disc substrate 12 is formed with relative height dimensions with respect to the region beyond the predetermined region within the 1 to 7 μm range.

Thus, because the outer periphery portion 14A of the recording surface 14 of the disc substrate 12 can be formed to the desired shape by the injection-molding process, increases in fabrication costs can be suppressed in comparison with, for example, a case of forming the outer periphery portion to the desired shape by extra machining of the outer periphery portion after molding.

Hereabove, the present invention has been described in detail with the above-described embodiment. However, the present invention is not limited thus, and various other embodiments are possible within the scope of the present invention.

For example, in the embodiment described above, at the predetermined region of the cavity 158 of the mold 150, the flat surface-form angled surface portion 164 is provided. However, the predetermined region is not limited thus; for example, a curved surface-form angled surface portion could be provided instead.

1. A method for fabricating an optical disc substrate which is to be employed in an optical disc on which information can be at least one of replayed and recorded for replay with laser light, the optical disc substrate being fabricated by injection-molding and the optical disc substrate structuring the optical disc by lamination of a thin film-form cover sheet at an information recording surface of the optical disc substrate, the cover sheet protecting the information recording surface, the method comprising:
forming an outer periphery portion of the information recording surface of the optical disc substrate, including forming a height of the outer periphery portion, in a region of up to 1 mm from an outer peripheral edge of the optical disc substrate to an inner side thereof along a surface direction of the information recording surface, to a relative height within a range of 1 to 7 μm with respect to a region of the outer periphery portion that is beyond said 1 mm.

2. The optical disc substrate fabrication method of claim 1, wherein forming the outer periphery portion comprises carrying out injection-molding with a mold which includes
a cavity which molds the optical disc substrate by molten resin, which is injected into the cavity from a center thereof, spreading and filling to a circumference of the cavity, and
an angled surface portion which is provided at a predetermined range of an area of the cavity that is for molding the outer periphery portion, and which makes a height dimension of the outer periphery portion gradually smaller from the inner side toward the outer side of the outer periphery portion.

3. An optical disc on which information can be at least one of replayed and recorded for replay with laser light, the optical disc comprising:
an optical disc substrate which is fabricated by injection-molding and includes an information recording surface, an outer periphery portion of the information recording surface of the optical disc substrate being formed to a height, in a region of up to 1 mm from an outer peripheral edge of the optical disc substrate to an inner side thereof along a surface direction of the information recording surface, which is a relative height within a range of 1 to 7 μm with respect to a region of the outer periphery portion that is beyond said 1 mm; and
a thin film-form cover sheet which is laminated at the information recording surface of the optical disc substrate for protecting the information recording surface.

4. The optical disc of claim 3, wherein the outer periphery portion is formed by injection-molding using a mold which includes
a cavity which molds the optical disc substrate by molten resin, which is injected into the cavity from a center thereof, spreading and filling to a circumference of the cavity, and
an angled surface portion which is provided at a predetermined range of an area of the cavity that is for molding the outer periphery portion, and which makes a height dimension of the outer periphery portion gradually smaller from the inner side toward the outer side of the outer periphery portion.

5. A mold for fabricating an optical disc substrate, the mold comprising:
a fixed mold;
a stamper disposed on the fixed mold;
a movable mold which is superposed on the fixed mold with the stamper interposed at a time of molding;
a stamper holder provided at an outer peripheral end portion of the movable mold; and
a cavity formed by superposition of the moveable mold on the fixed mold,
wherein an angled surface portion is formed at an outer periphery portion of the fixed mold such that a height of the outer periphery portion becomes gradually higher from an inner side toward an outer side of the outer periphery portion.

6. The mold of claim 5, wherein the stamper holder comprises a substantially ring shape.

7. The mold of claim 5, wherein the cavity forms a space including a circular plate-shaped space.

8. The mold of claim 6, wherein the cavity forms a space including a circular plate-shaped space.

9. The mold of claim 5, wherein a channel is formed in the fixed mold, at a position corresponding to a central region of the cavity, for injection into the cavity of a molding material which is a material of the disc substrate.

10. The mold of claim 7, wherein a channel is formed in the fixed mold, at a position corresponding to a central region of the cavity, for injection into the cavity of a molding material which is a material of the disc substrate.

11. The mold of claim 5, wherein the angled surface portion is formed at a surface of the fixed mold in a region of substantially 1 mm from an outer side toward an inner side of an outer peripheral end portion of an area at which the disc substrate will be formed at the time of molding.

12. The mold of claim 5, wherein a maximum height difference within the angled surface portion is substantially between 1 and 7 μm.

13. The mold of claim 7, wherein a maximum height difference within the angled surface portion is substantially between 1 and 7 μm.

14. The mold of claim 11, wherein a maximum height difference within the angled surface portion is substantially between 1 and 7 μm.

15. The mold of claim 5, wherein grooves for transcription are formed at one face of the stamper.

16. The mold of claim 15, wherein the stamper is placed on the fixed mold with the face at which the grooves are formed oriented upward.

17. The mold of claim 5, wherein the stamper holder presses an outer peripheral end portion vicinity of the stamper against the fixed mold.

18. The mold of claim 6, wherein the stamper holder presses an outer peripheral end portion vicinity of the stamper against the fixed mold.

19. The mold of claim 16, wherein the stamper holder presses an outer peripheral end portion vicinity of the stamper against the fixed mold.

20. The mold of claim 5, wherein the stamper holder presses an outer peripheral end portion vicinity of the stamper against the fixed mold at positions other than the angled surface portion.
